(19) United States
(12) Patent Application Publication
(10) Pub. No.: US 2011/0131512 A1
(43) Pub. Date: Jun. 2, 2011

(54) UPDATEABLE RUNNING APPLICATION

(75) Inventors: Xin Yan, Bellevue, WA (US); Joseph S. Binder, Seattle, WA (US); Malik Bilal Waheed, Redmond, WA (US); Sudhanshu Kulkarni, Redmond, WA (US)

(73) Assignee: Microsoft Corporation, Redmomd, WA (US)

(21) Appl. No.: 12/629,061

(22) Filed: Dec. 2, 2009

(51) Int. Cl. G06F 3/048

(52) U.S. Cl. 715/763

(57) ABSTRACT

An application can be run and initial user interface definitions for the application can be loaded into memory. The application can use the initial user interface definitions in the memory to present an initial user interface for the application. In response to user input, one or more updates can be made to the initial user interface definitions in the memory, and the application can use the updated user interface definitions to present an updated user interface for the application. Presenting the initial user interface, making the updates, and using the updated definitions to present the updated user interface can be done while the application continues to run.

### BACKGROUND

Developing user interfaces for applications can be a highly iterative process, often requiring developers to make incremental adjustments to an application's user interface in order to present information to end-users effectively. For example, developers may provide user input to construct the user interface in a development tool (as used herein a “development tool” refers to a tool for developing software—examples include Microsoft's Visual Studio® development system); compile the application to apply the changes; run the application to visualize the extent to which the changes effectively present data; stop the application to apply further changes; and so on.

Some applications may allow end users to modify application settings to change the way the application looks (changing the “skin” of an application, etc.). However, such changes are typically defined by the developer in the user interface definitions; accordingly, such settings typically do not ease the burden on the developer during the development of the software. As used herein, user interface definitions for an application define the application's user interface. User interface definitions are included in the application when the application is being developed, and are typically not modifiable by end users in the ordinary course of running the application. Accordingly, an end user manipulating pre-defined user interface settings to switch between alternative pre-defined user interface presentations is not considered to be updating the user interface definitions themselves.

### SUMMARY

The validity and/or effectiveness of an application's user interface often cannot be assessed until the application is run, especially if the user interface is to present significant amounts of application data (data that can be accessed by an application, but that may be provided and/or modified after an application has been compiled). This running of the application to assess iterative changes can slow down the overall development process described above. The tools and techniques described herein can allow an application's user interface to be updated while the application is running, which may speed up the development process and/or provide other benefits, such as allowing the development process to be more natural for a developer.

In one embodiment, the tools and techniques can include running an application and loading initial user interface definitions for the application into memory. The application can use the initial user interface definitions in the memory to present an initial user interface for the application. In response to user input, one or more updates can be made to the initial user interface definitions in the memory, and the application can use the updated user interface definitions in the memory to present an updated user interface for the application. Presenting the initial user interface, making the updates, and using the updated definitions to present the updated user interface can be done while the application continues to run.

In another embodiment of the tools and techniques, an initial application development project can be compiled as an application that includes application logic and initial user interface definitions. The application can be run to execute the application logic, load the initial user interface definitions into memory, and present application data according to the initial user interface definitions. While the application is running, one or more updates can be made to the initial user interface definitions in the memory, and the application data can be presented according to resulting updated user interface definitions. Moreover, the initial application development project can be updated to reflect the updates to the user interface definitions in the memory.

In yet another embodiment of the tools and techniques, an application can be run to execute application logic, load initial user interface definitions for the application into memory, and present an initial user interface according to the initial user interface definitions. While the application is running, user input can be received at the application, one or more updates can be made to the initial user input definitions in memory, and an updated user interface can be presented according to the updated user interface definitions. The update(s) can also be communicated to a development tool running in a different process from the application.

This Summary is provided to introduce a selection of concepts in a simplified form. The concepts are further described below in the Detailed Description. This Summary is not intended to identify key features or essential features of the claimed subject matter, nor is it intended to be used to limit the scope of the claimed subject matter. Similarly, the invention is not limited to implementations that address the particular techniques, tools, environments, disadvantages, or advantages discussed in the Background, the Detailed Description, or the attached drawings.

### BRIEF DESCRIPTION OF THE DRAWINGS

FIG. 1 is a block diagram of a suitable computing environment in which one or more of the described embodiments may be implemented.

FIG. 2 is block diagram of an updateable running application environment.

FIG. 3 is an illustration of an initial user interface.

FIG. 4 is an illustration of the user interface of FIG. 3 with the application in customization mode.

FIG. 5 is an illustration similar to FIG. 4, but with an entry for an item in a content tree editor selected.

FIG. 6 is an illustration similar to FIG. 5, but with a user interface item being updated from a list configuration to a data grid configuration.

FIG. 7 is an illustration similar to FIG. 5, but with the application out of customization mode.

FIG. 8 is an illustration similar to FIG. 5, but with a different entry for an item in the content tree editor selected.

FIG. 9 is an illustration similar to FIG. 8, but with a drop-down list in a property editor being active.

FIG. 10 is an illustration similar to FIG. 8, but with a group of user interface item labels updated from left justification to right justification.

FIG. 11 is an illustration similar to FIG. 10, but with the application out of customization mode.

FIG. 12 is a flow diagram of a technique for an updateable running application.

FIG. 13 is a flow diagram of another technique for an updateable running application.

FIG. 14 is a flow diagram of yet another technique for an updateable running application.

### DETAILED DESCRIPTION

Embodiments described herein are directed to techniques and tools for improved application development using updateable running applications. Such improvements may result from the use of various techniques and tools separately or in combination.

Such techniques and tools may include running a compiled application that includes initial user interface definitions. The application can load the initial user interface definitions in memory and present an initial user interface according to the initial user interface definitions. For example, the application may present application data in a user interface according to the initial user interface definitions. A user can provide user input (e.g., by making a set of one or more gestures such as a mouse click, keystroke, etc.). In response to the user input, the application can update the user interface definitions in memory. Moreover, the application can present an updated user interface according to the resulting updated user interface definitions. In addition, the updates can be communicated to a development tool, and the development tool can merge the updates with a development project from which the application was compiled.

Accordingly, one or more substantial benefits can be realized from the updateable running application tools and techniques described herein. For example, an application developer can run the actual compiled application and indicate desired updates to the application user interface while the application is still running. In response to the developer's actions, the application can automatically update the user interface definitions and present an updated user interface. Additionally, the updates can be made to the development project from which the application was compiled. Accordingly, a developer can see the user interface in the actual running application, can make updates to the user interface, and can see those updates in the running application almost immediately after requesting the updates.

The subject matter defined in the appended claims is not necessarily limited to the benefits described herein. A particular implementation of the invention may provide all, some, or none of the benefits described herein. Moreover, a particular implementation may provide additional benefits not mentioned herein. Although operations for the various techniques are described herein in a particular, sequential order for the sake of presentation, it should be understood that this manner of description encompasses rearrangements in the order of operations, unless a particular ordering is required. For example, operations described sequentially may in some cases be rearranged or performed concurrently. Techniques described herein with reference to flowcharts may be used with one or more of the systems described herein and/or with one or more other systems. For example, the techniques described herein may be implemented with hardware or software, or a combination of both. Moreover, for the sake of simplicity, flowcharts may not show the various ways in which particular techniques can be used in conjunction with other techniques.

### I. Exemplary Computing Environment

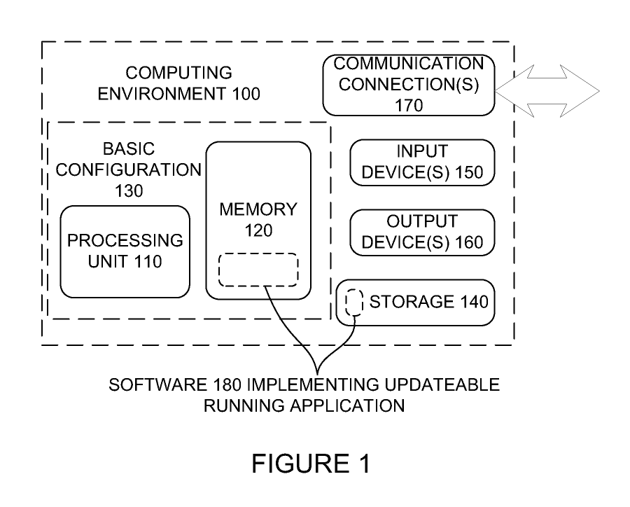

FIG. 1 illustrates a generalized example of a suitable computing environment (100) in which one or more of the described embodiments may be implemented. For example, one or more such computing environments can be used as a computing environment for an updateable running application. Generally, various different general purpose or special purpose computing system configurations can be used. Examples of well-known computing system configurations that may be suitable for use with the tools and techniques described herein include, but are not limited to, server farms and server clusters, personal computers, server computers, hand-held or laptop devices, multiprocessor systems, microprocessor-based systems, programmable consumer electronics, network PCs, minicomputers, mainframe computers, distributed computing environments that include any of the above systems or devices, and the like.

The computing environment (100) is not intended to suggest any limitation as to scope of use or functionality of the invention, as the present invention may be implemented in diverse general-purpose or special-purpose computing environments.

With reference to FIG. 1, the computing environment (100) includes at least one processing unit (110) and memory (120). In FIG. 1, this most basic configuration (130) is included within a dashed line. The processing unit (110) executes computer-executable instructions and may be a real or a virtual processor. In a multi-processing system, multiple processing units execute computer-executable instructions to increase processing power. The memory (120) may be volatile memory (e.g., registers, cache, RAM), non-volatile memory (e.g., ROM, EEPROM, flash memory), or some combination of the two. The memory (120) stores software (180) implementing an updateable running application.

Although the various blocks of FIG. 1 are shown with lines for the sake of clarity, in reality, delineating various components is not so clear and, metaphorically, the lines of FIG. 1 and the other figures discussed below would more accurately be grey and fuzzy. For example, one may consider a presentation component such as a display device to be an I/O component. Also, processors have memory. The inventors hereof recognize that such is the nature of the art and reiterate that the diagram of FIG. 1 is merely illustrative of an exemplary computing device that can be used in connection with one or more embodiments of the present invention. Distinction is not made between such categories as “workstation,” “server,” “laptop,” “handheld device,” etc., as all are contemplated within the scope of FIG. 1 and reference to “computer,” “computing environment,” or “computing device.”

A computing environment (100) may have additional features. In FIG. 1, the computing environment (100) includes storage (140), one or more input devices (150), one or more output devices (160), and one or more communication connections (170). An interconnection mechanism (not shown) such as a bus, controller, or network interconnects the components of the computing environment (100). Typically, operating system software (not shown) provides an operating environment for other software executing in the computing environment (100), and coordinates activities of the components of the computing environment (100).

The storage (140) may be removable or non-removable, and may include computer-readable storage media such as magnetic disks, magnetic tapes or cassettes, CD-ROMs, CD-RWs, DVDs, or any other medium which can be used to store information and which can be accessed within the computing environment (100). The storage (140) stores instructions for the software (180).

The input device(s) (150) may be a touch input device such as a keyboard, mouse, pen, or trackball; a voice input device; a scanning device; a network adapter; a CD/DVD reader; or another device that provides input to the computing environment (100). The output device(s) (160) may be a display, printer, speaker, CD/DVD-writer, network adapter, or another device that provides output from the computing environment (100).

The communication connection(s) (170) enable communication over a communication medium to another computing entity. Thus, the computing environment (100) may operate in a networked environment using logical connections to one or more remote computing devices, such as a personal computer, a server, a router, a network PC, a peer device or another common network node. The communication medium conveys information such as data or computer-executable instructions or requests in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

The tools and techniques can be described in the general context of computer-readable media. Computer-readable media are any available media that can be accessed within a computing environment. By way of example, and not limitation, with the computing environment (100), computer-readable media include memory (120), storage (140), and combinations of the above.

The tools and techniques can be described in the general context of computer-executable instructions, such as those included in program modules, being executed in a computing environment on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing environment. In a distributed computing environment, program modules may be located in both local and remote computer storage media.

For the sake of presentation, the detailed description uses terms like “determine,” “choose,” “adjust,” “send,” and “operate” to describe computer operations in a computing environment. These and other similar terms are high-level abstractions for operations performed by a computer, and should not be confused with acts performed by a human being, unless performance of an act by a human being (such as a “user”) is explicitly noted. The actual computer operations corresponding to these terms vary depending on the implementation.

### II. Updateable Running Application System and Environment

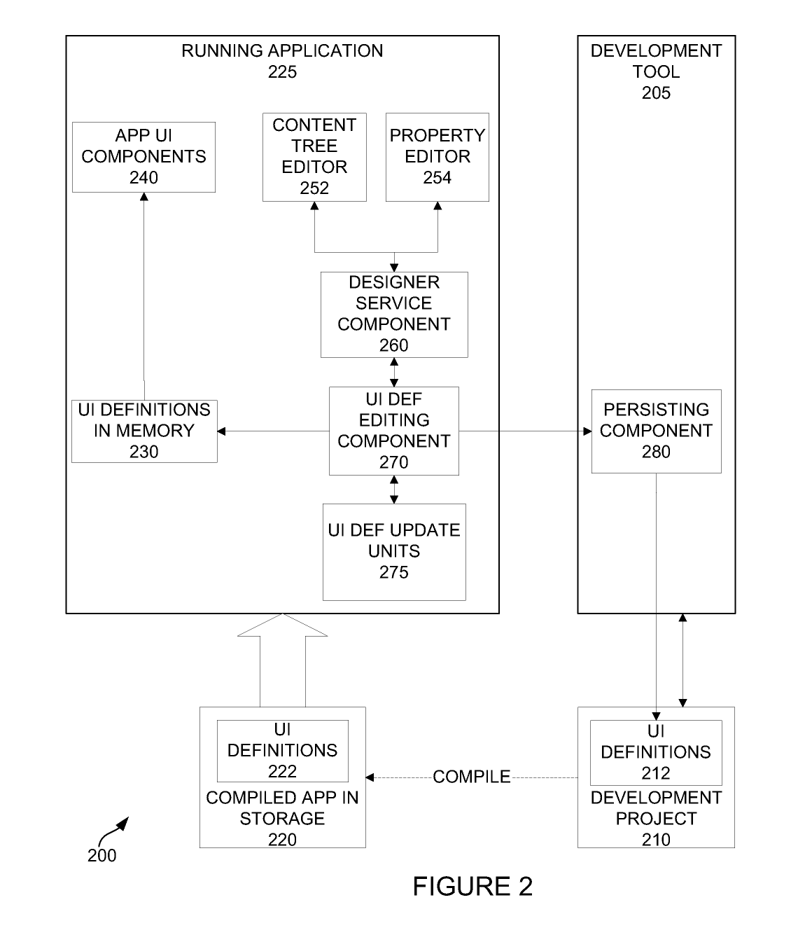

FIG. 2 is a block diagram of an updateable running application environment (200) in conjunction with which one or more of the described embodiments may be implemented. The environment (200) is illustrated in simplified form in FIG. 2, but the environment (200) may include additional components, such as components similar to those of the computing environment (100) discussed above. Indeed, the environment (200) may include multiple computing environments similar to the computing environment (100) (e.g., one environment at one machine for the running application and another environment at a different machine for the development tool, with communications between the environments being conducted over a network, such as a global computer network or local area network). The components of the environment (200) and their functions will now be discussed.

The environment (200) can include a development tool (205), such as Microsoft's Visual Studio® development system. The development tool (205) can be used to produce a development project (210), and to store it in persistent storage. The development project (210) can be written in one or more of various software development languages, including source code, markup languages such as XML, etc. The development project (210) can include application logic, as well as user interface definitions (212), which respectively define the logic and user interface for an application (220) to be compiled from the development project (210). The user interface definitions (212) could be in any of various different languages, but in one implementation the user interface definitions are written in a user interface modeling language that is built on the XML standard. The user interface definitions (212) can include standard types of definitions, including screen layout definitions, identifications of user interface elements, user interface element properties (e.g., display names, descriptions, user interface control identification, object(s) to which the user interface element is bound).

The compiled application (220) can be stored in persistent storage and/or in volatile storage, and can include stored user interface definitions (222). For example, the development tool (205) or a different tool may be used to compile the development project. As used herein, compiling refers to transforming and/or organizing a development project into an application that can be run. This compiling can use standard compiling techniques, and can be done at or prior to runtime. Compiling may include compiling source code into object code, placing markup language documents in accessible and useable form, etc.

The application (220) in storage can be loaded as a running application (225), which can include loading the user interface definitions (222) from storage to provide the user interface definitions (230) in memory. The running application (225) can present a user interface with one or more application user interface components (240) according to the user interface definitions (230) in memory. For example, the application (225) may present application data with the user interface components (240) according to the user interface definitions (230).

Referring still to FIG. 2, the running application (225) can enter a customization mode in which one or more user interface definition editors, such as a content tree editor (252) and a property editor (254), can be presented to the developer along with the regular application user interface components (240). For example, the content tree editor (252) can be a hierarchical view of the user interface elements on the screen (320). The content tree editor (252) can represent and allow a developer to modify user interface definitions that define the overall layout and the content of the user interface components (240) for the application. The property editor (254) can represent and allow a developer to modify user interface definitions that define properties of individual user interface elements and groups of elements (such as properties of an overall screen).

The content tree editor (252) and the property editor (254) can be hosted by a designer service component (260), which can also receive user input from the editors (252 and 254), indicating updates to the user interface definitions (230) in memory. In response to receiving such user input, the designer service component (260) can update the user interface definitions (230) in memory through a user interface definition editing component (270). The running application (225) can listen for changes to the user interface definitions (230) in memory, so that when the user interface definitions (230) in memory are updated, the running application (225) can respond by updating the user interface components (240). Accordingly, a developer can indicate a change to the user interface definitions (230) in memory through the editors (252 and 254), and the running application (225) can present the updated user interface for the running application (225) to the developer almost immediately in response to the developer's input. Accordingly, substantial time can be saved for a developer who is iteratively updating user interface definitions and viewing those updates in the running application.

The user interface definition editing component (270) can also save user interface definition update units (275) to memory. The user interface definition editing component (270) can also cancel user interface definition updates by using those update units (275) to reverse the updates in the user interface definitions (230) in memory. In addition, the user interface definition editing component (270) can communicate user interface definition updates to a persisting component (280) in the development tool (205). For example, the updates can be communicated across a dedicated communication channel. In response, the persisting component (280) can merge the user interface definition updates with the user interface definitions (212) in the development project (210) from which the running application (225) was compiled.

When the application development project (210) is finalized, it may be compiled without providing the functionality of the components for editing the user interface definitions. For example, the content tree editor (252), property editor (254), designer service component (260), and/or the user interface definition editing component (270) may be omitted from the compiled application that is provided to end users. Alternatively, one or more of those components can be de-activated in the final application.

### III. Example of User Interface Displays for an Updateable Running Application

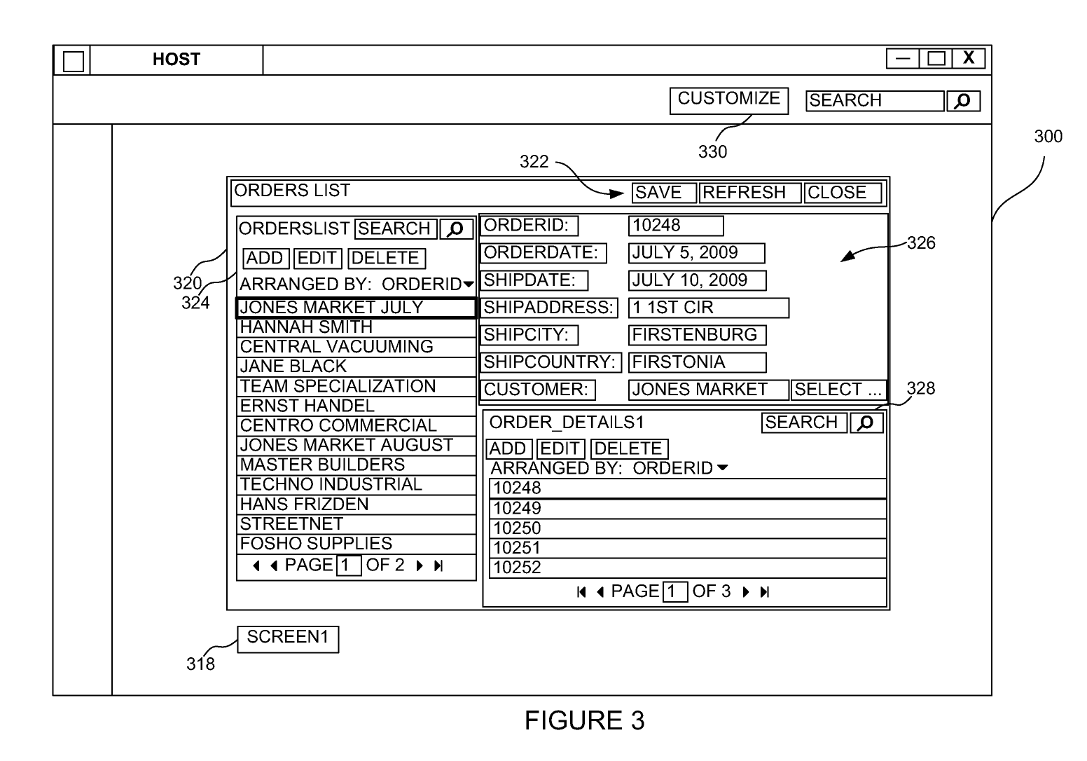

An example of user interface displays that can be provided by an updateable running application will now be discussed with reference to FIGS. 3-7 and FIGS. 8-11. However, the updateable running application tools and techniques described herein are not limited to a specific user interface or even a specific type of user interface; rather, the tools and techniques can be applied to a wide variety of different user interfaces and user interface types. In FIGS. 3-11, the same reference numbers are used to refer to corresponding features in different figures, although some of those features change in different figures (the overall user interface changing from one figure to another, a user interface item changing from a list to a data grid, etc.).

Referring now to FIG. 3, an example of a user interface (300) will be discussed. The user interface (300) may be run on a host, such as a browser host running the application with a Microsoft Silverlight® browser plug-in. The user interface (300) can include an identifier (318) of a screen (320), which can also be displayed within the user interface (300).

The screen (320) can include standard operational buttons (322), such as “SAVE,” “REFRESH,” and “CLOSE.” The screen (320) can be generally laid out in left and right columns. The left column can include a user interface element in the form of a list (324). The list (324) can present application data, such as titles for merchandise orders. The right column of the screen (320) can be arranged in a vertical stack. The top of the stack can include user interface items (326) (ORDERID, ORDERDATE, SHIPDATE, SHIPADDRESS, SHIPCITY, SHIPCOUNTRY, and CUSTOMER) that represent fields for a selected order from the list (324). Below the user interface items (326) in the right column of the screen (320), a user interface item (328) in the form of a list can present a list of orders.

Moreover, the user interface (300) can include a user interface element in the form of a button (330) that is titled “CUSTOMIZE.” The CUSTOMIZE button (330) can be selected by a developer to provide user input, which results in the application entering a customization mode.

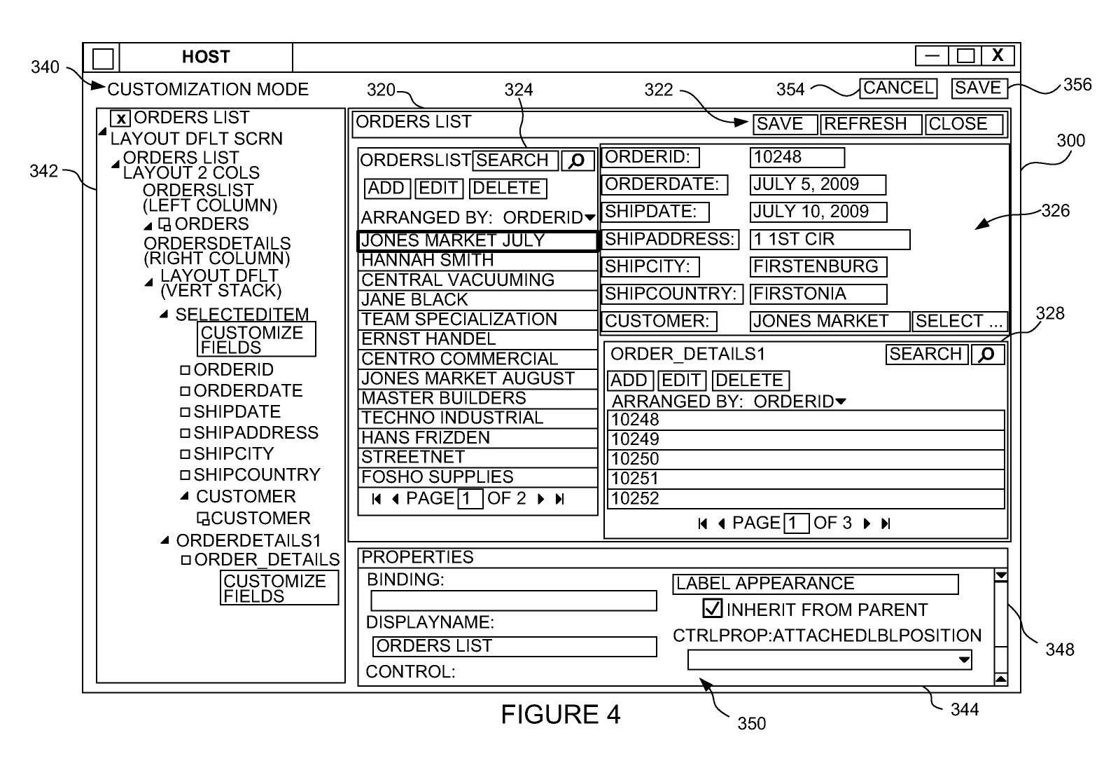

Referring now to FIG. 4, an example of the user interface (300) of FIG. 3 in customization mode will be discussed. In customization mode, the user interface (300) can still display the application screen (320). In addition, the user interface (300) can include an indication (340) that the application is in customization mode. Additionally, the user interface (300) can include a content tree editor (342), which can list various user interface items on the screen (320), as well as overall formatting definitions for the screen (320) and/or various areas of the screen (320) (e.g., properties of the left column and properties of the right column). The user interface (300) can also include a properties editor (344), which can include a scroll bar (348) for navigating a properties list (350). The properties list (350) can include properties for the overall screen (320) if nothing is selected in the content tree editor (342), or properties for a selected item in the content tree editor (342) if an item in the content tree editor (342) is selected. As illustrated in FIG. 4, nothing in the content tree editor (342) is selected, so the properties list (350) includes properties for the screen (320), such as the screen display name, “ORDERS LIST.”

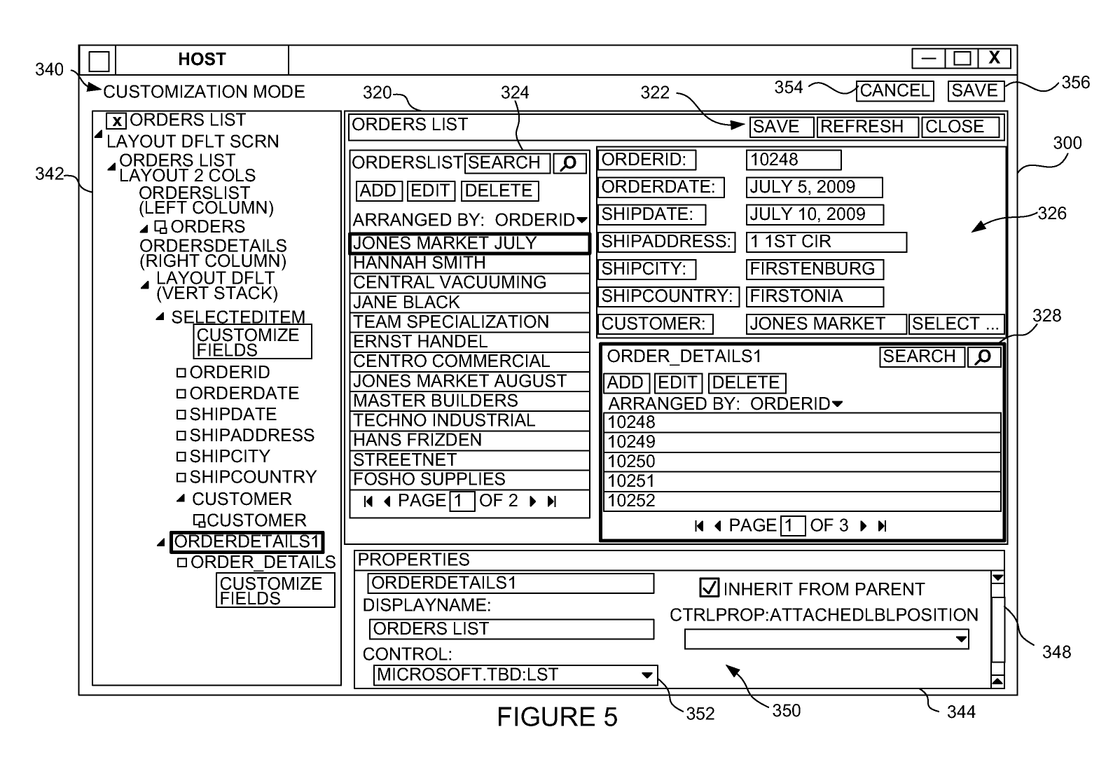

Referring to FIG. 5, if a developer selects the entry for the item “ORDERDETAILS1” in the content tree editor (342), the entry for the item can be highlighted in the content tree editor (342), such as by including a highlighting border around the entry (as illustrated by the bolded border in FIG. 5) and/or changing a background color of the entry. The corresponding item (328) itself can also be highlighted on the screen (320), such as by including a highlighting border around the item (328), as illustrated in FIG. 5. Moreover, the properties list (350) in the properties editor (344) can list properties for the selected item.

The developer can provide user input by manipulating the scroll bar (348) to scroll down the properties list (350) to a property to be updated. For example, the developer can scroll down to reveal a user interface control property element (352), which initially defines the control for the user interface element as “MICROSOFT.TBD.LST.” As an example, initially this control property may be defined as in the following user interface modeling language excerpt from stored user interface definitions (see the following line: View=“Microsoft.Tbd:List”):

<m:ContentItem DataType=“Application2:CollectionView$Order_Details”
ItemName=“Order_DetailsList”

Kind=“Collection”
View=“Microsoft.Tbd:List”>
<m:ContentItem.DataSource>

<m:ScreenExpressionTree>

<m:ChainExpression>

<m:MemberExpression
Member=“Application2:Screen1%Members[Order_Details1]” />

</m:ChainExpression>

</m:ScreenExpressionTree>

</m:ContentItem.DataSource>

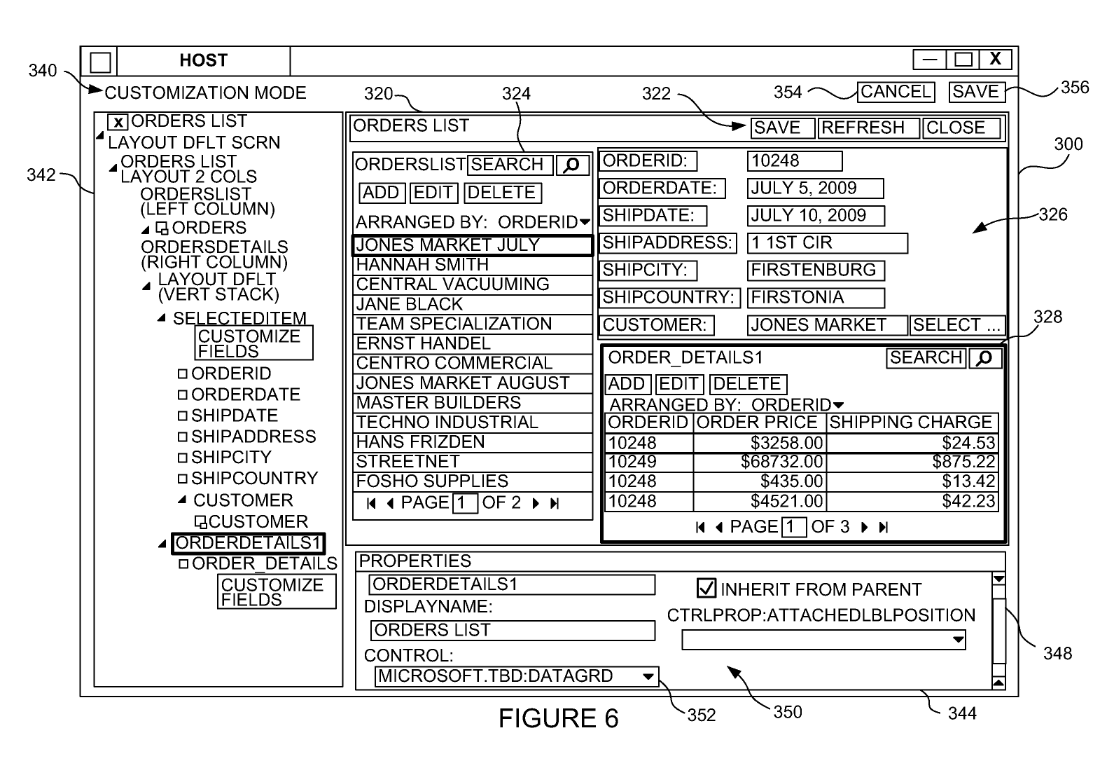

The developer can provide user input to update the control property element (352) to a different user interface control, such as by selecting a different control from a drop-down list or menu. For example, referring now to FIG. 6, the control property element (352) can be updated to “MICROSOFT.TBD.DATAGRD”, defining the control for the user interface item (328) on the screen (320) as a data grid, rather than a list. The user input provided by the developer can result in the user interface definitions being updated in memory, which can result in the running application updating the user interface item (328) on the screen (320) to a data grid configuration, as illustrated in FIG. 6.

Accordingly, after a developer makes a gesture to provide user input to update the control for the user interface item (328), the developer can view the running application's presentation of application data in the user interface item (328) according to the updated user interface definition almost immediately.

A developer can prompt the running application to cancel the update to the user interface item (328) (possibly along with any other pending updates) by selecting a CANCEL button (354). Alternatively, the developer may continue to make additional updates to user interface definitions by interacting with the content tree editor (342) and the properties editor (344). When the developer is ready to save the updates to the development project in persistent storage, the developer can select a SAVE button (356). This can result in the user interface definitions editing component in the running application saving any pending updates in persistent storage by communicating the updates to the persisting component in the development tool, so that the persisting component can merge the changes with the development project in persistent storage. Additionally, the updates may be saved in persistent storage in the environment for the running application. For example, the initial user interface modeling language excerpt above can be changed to the following in the development project (see the following line: View=“Microsoft.Tbd:DataGrid”):

<m:ContentItem DataType=“Application2:CollectionView$Order_Details”

ItemName=“Order_DetailsList”
Kind=“Collection”
View=“Microsoft.Tbd:DataGrid”>
<m:ContentItem.DataSource>

<m:ScreenExpressionTree>

<m:ChainExpression>

<m:MemberExpression
Member=“Application2:Screen1%Members[Order_Details1]” />

</m:ChainExpression>

</m:ScreenExpressionTree>

</m:ContentItem.DataSource>

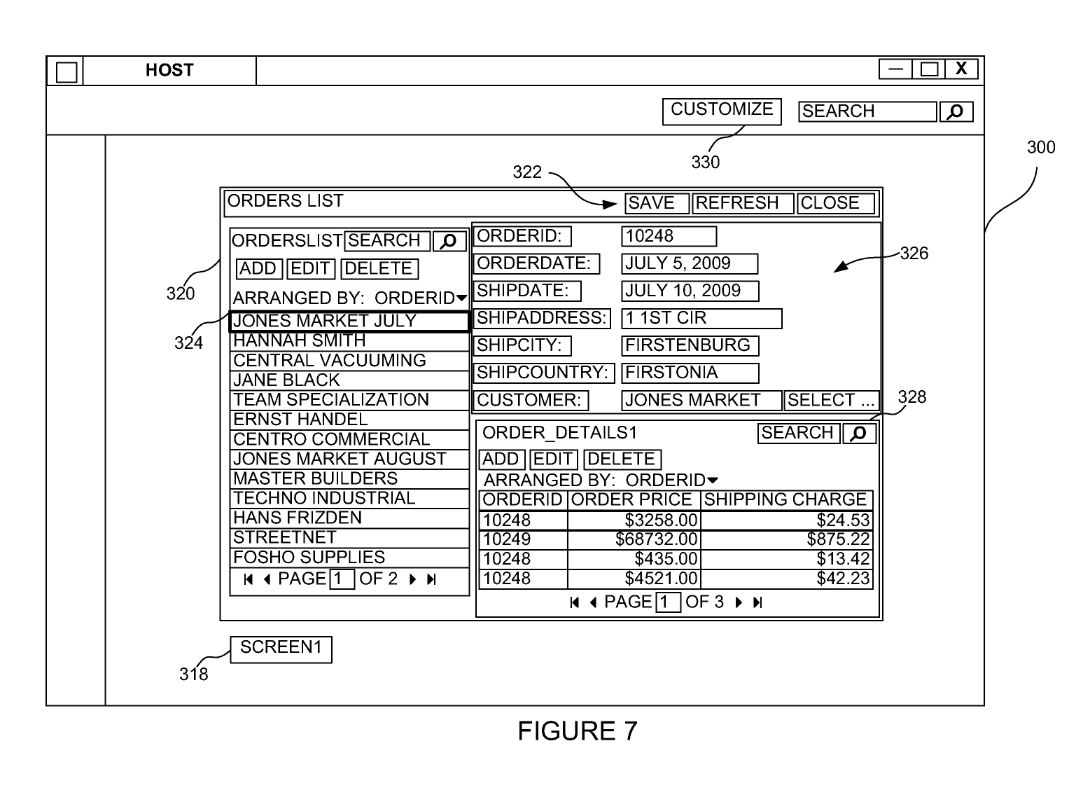

Referring now to FIG. 7, if the developer chooses to save the changes, the application can exit from the customization mode. However, the application can continue to run, presenting the developer with the user interface (300) in a configuration similar to FIG. 3, but with the user interface item (328) still updated from a list configuration to a grid configuration. The developer can continue to interact with the running application, and can later re-enter the customization mode by selecting the CUSTOMIZE button (330).

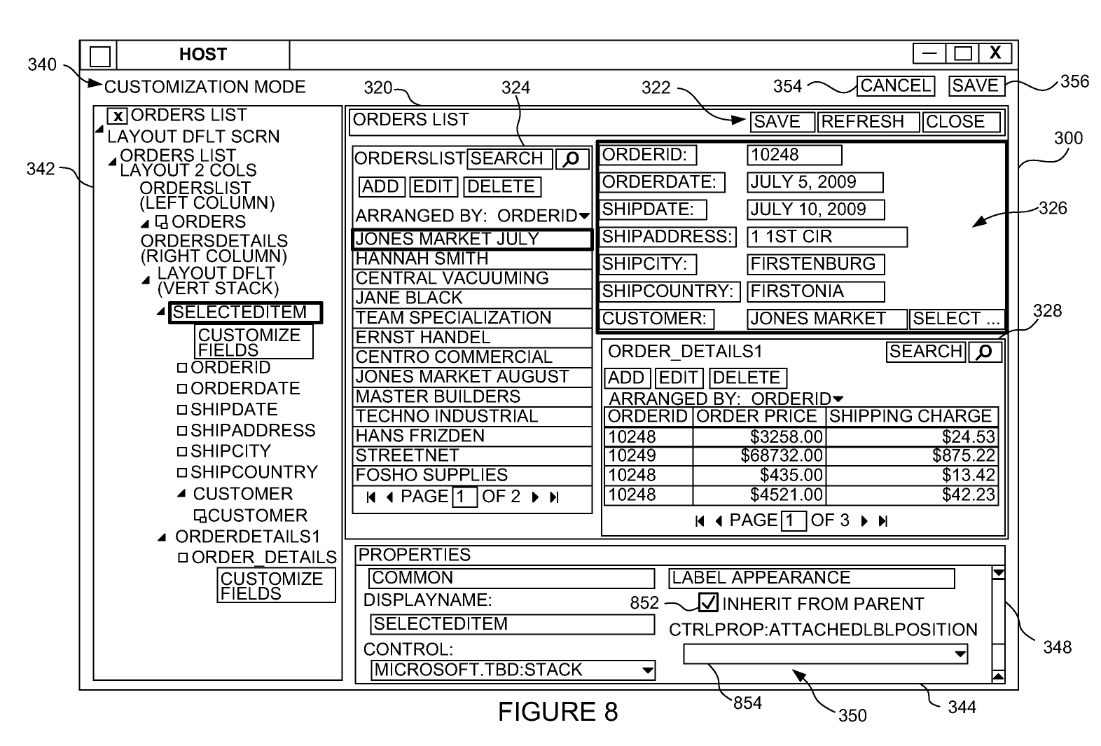

Referring now to FIG. 8, another example of a user interface change will be discussed, where a change is made to a label position property for the user interface items (326) (ORDERID, ORDERDATE, SHIPDATE, SHIPADDRESS, SHIPCITY, SHIPCOUNTRY, and CUSTOMER) that represent fields for a selected order from the list (324). As illustrated in FIG. 8, a developer has re-entered customization mode by selecting the CUSTOMIZE button (330). The developer has also selected a “SELECTEDITEM” entry in the content tree editor (342). In response to that selection, the property editor (344) can display properties for the SELECTEDITEM area of the screen (320), which includes the user interface items (326) that represent the fields for a selected order from the list (324). The properties list (350) in the property editor (344) can include, among other things, a label appearance list, which can include a checkbox (852), indicating whether the label appearance is inherited from the parent, and a label property element (854) in the form of a drop-down list. With the checkbox (852) checked, as illustrated in FIG. 8, the label property element (854) can be inactive because the label property is inherited from the parent of the selected item in the content tree editor (342).

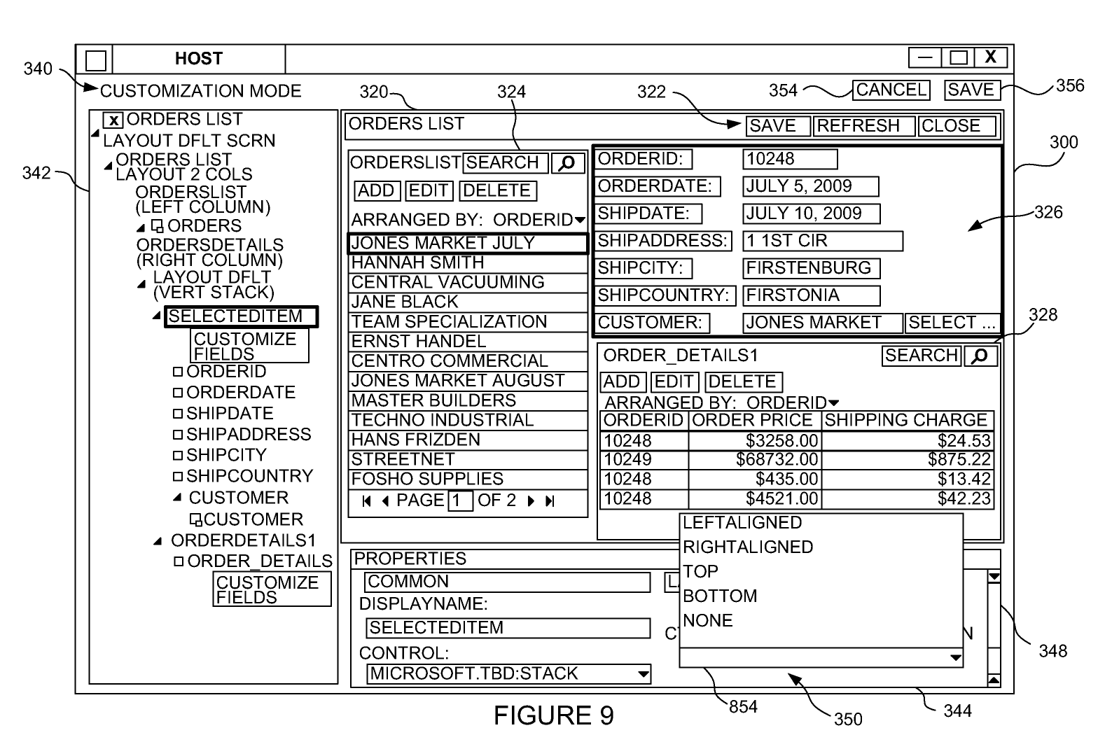

However, if the developer un-checks the checkbox (852), the label property element (854) can become active, as illustrated in FIG. 9. The label property element (854) can include a list of available label properties (LEFTALIGNED, RIGHTALIGNED, TOP, BOTTOM, and NONE), which can determine the alignment of the labels (ORDERID, ORDERDATE, SHIPDATE, SHIPADDRESS, SHIPCITY, SHIPCOUNTRY, and CUSTOMER) listed on the left of the user interface items (326). As illustrated in FIG. 9, the labels are left aligned, which is the alignment property inherited from the parent (e.g., from the ORDERDETAILS (RIGHT COLUMN) entry listed in the content tree editor (342)).

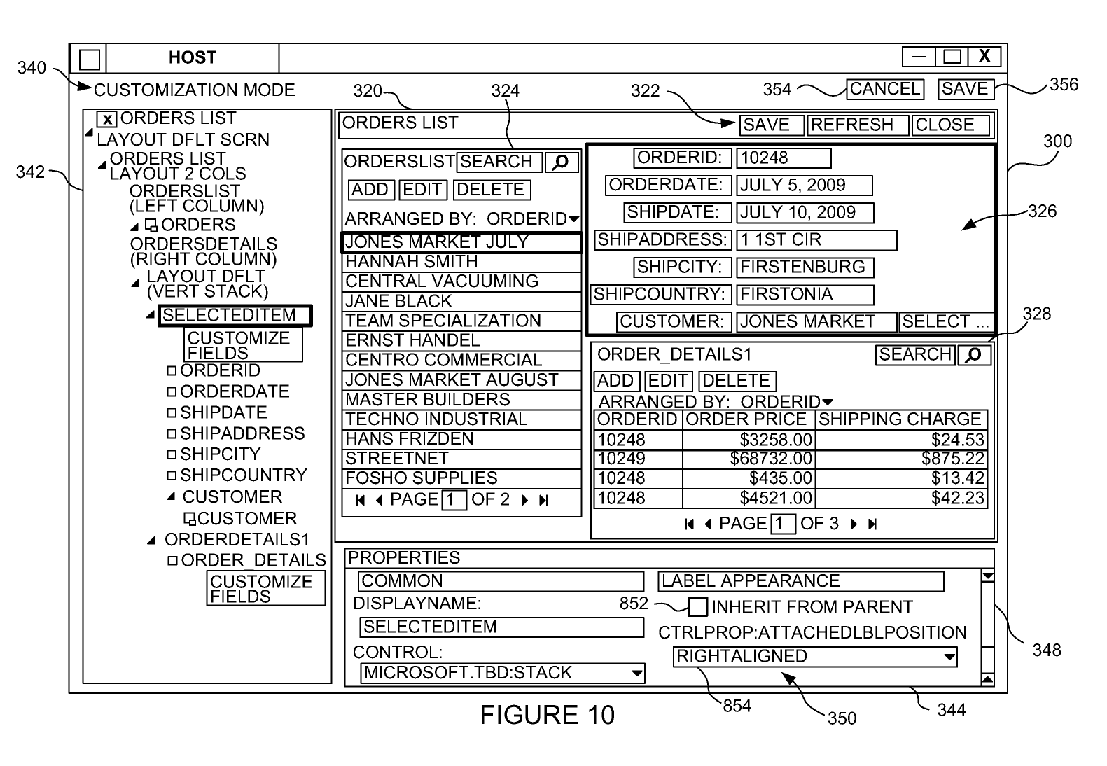

If the developer makes a gesture to select the RIGHTALIGNED entry in the label property element (854), then the user interface definitions can be updated in memory, which can result in the running application updating the user interface items (326) on the screen (320) to be right aligned, as illustrated in FIG. 10.

Accordingly, after a developer makes a gesture to provide user input to update the label appearance for the user interface items (326), the developer can view the running application's presentation of application data in the user interface items (326) according to the updated user interface definition almost immediately.

As noted above, a developer can prompt the running application to cancel the update to the user interface items (326) (possibly along with any other pending updates) by selecting a CANCEL button (354). Alternatively, the developer may continue to make additional updates to user interface definitions by interacting with the content tree editor (342) and the properties editor (344). When the developer is ready to save the updates to the development project in persistent storage, the developer can select a SAVE button (356). As discussed above, this can result in the user interface definitions editing component in the running application saving any pending updates in persistent storage by communicating the updates to the persisting component in the development tool, so that the persisting component can merge the changes with the development project in persistent storage. Additionally, the updates may be saved in persistent storage in the environment for the running application.

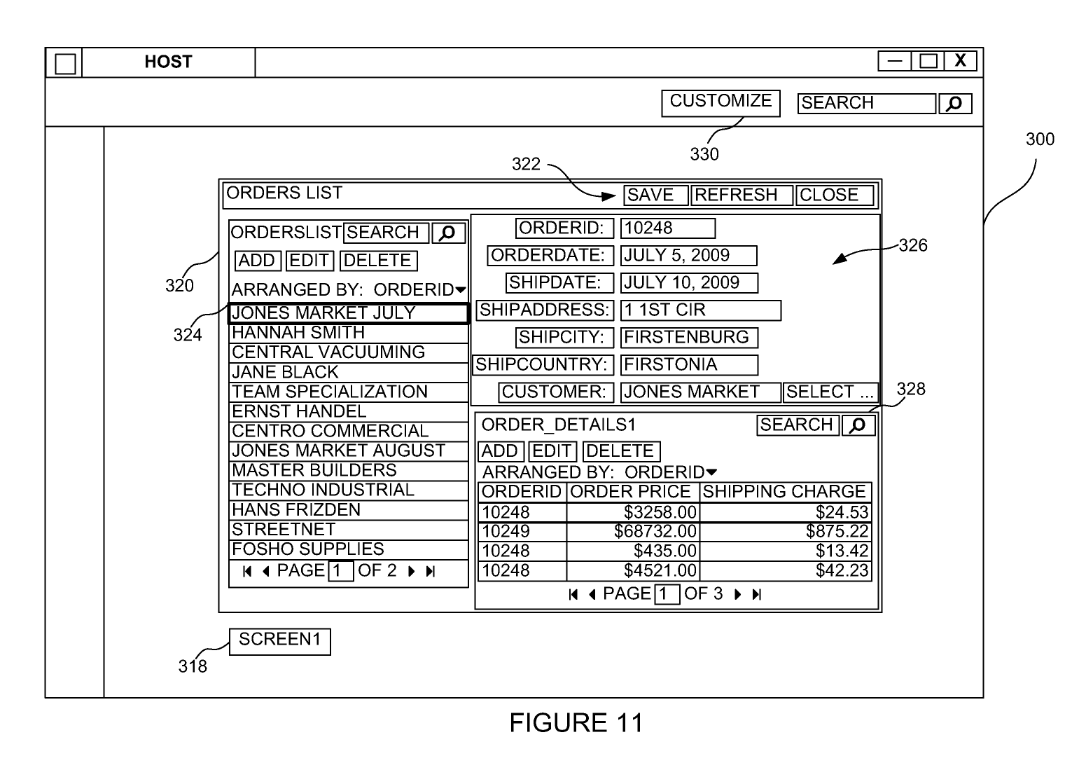

If the developer chooses to save the changes, the application can exit from the customization mode. However, the application can continue to run, as illustrated in FIG. 11, presenting the developer with the user interface (300) in a configuration similar to FIG. 7, but with the labels for the user interface items (326) still updated from left justification to right justification. The developer can continue to interact with the running application, and can later re-enter the customization mode by selecting the CUSTOMIZE button (330).

### IV. Updateable Running Application Techniques

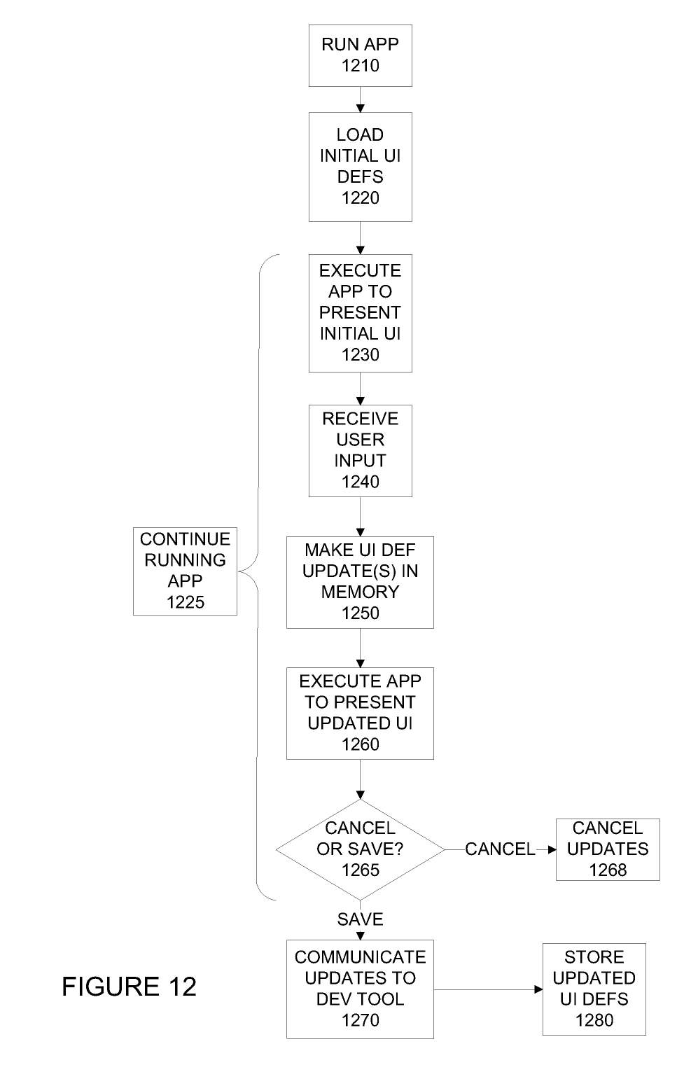

Referring to FIG. 12, an updateable running application technique will be discussed. The technique can include running (1210) an application and loading (1220) initial user interface definitions for the application into memory, such as from persistent storage into system memory (i.e., memory where current programs and data that are in use are held). The following can be performed while continuing (1225) to run the application: executing (1230) the application to use the initial user interface definitions in the memory to present an initial user interface for the application; receiving (1240) user input at the running application; in response to the user input, making (1250) one or more updates to the initial user interface definitions in the memory to produce updated user interface definitions in the memory; executing (1260) the application to use the updated user interface definitions in the memory to present an updated user interface for the application; determining (1265) whether to save or cancel the update(s) to the initial user interface definitions; and, if the updates are to be cancelled, then cancelling (1268) the one or more updates in response to receiving additional user input. The cancelling (1268) can include reverting from the updated user interface definitions in memory back to the initial user interface definitions in memory.

If the updates are to be saved, the technique can include communicating (1270) the one or more updates to a development tool, such as a tool running in a different process from the application and possibly on a different machine from the running application. Additionally, the technique can include storing (1280) updated user interface definitions that represent the one or more updates in persistent storage, such as by merging the updates with a development project from which the running application was compiled. Storing the updated user interface definitions can include storing the definitions in an environment that includes the running application and/or in an environment that includes a development tool running in a different process from the running application.

The update(s) can be made (1250) from the running application, such as by one or more components within the application that are dedicated to user interface definition updates. Also, executing (1230) the application to use the initial user interface definitions in the memory to present an initial user interface for the application can include accessing application data and presenting the application data according to the initial user interface definitions. Similarly, executing (1260) the application to use the updated user interface definitions in the memory to present an updated user interface for the application can include accessing the data and presenting the data according to the updated user interface definitions.

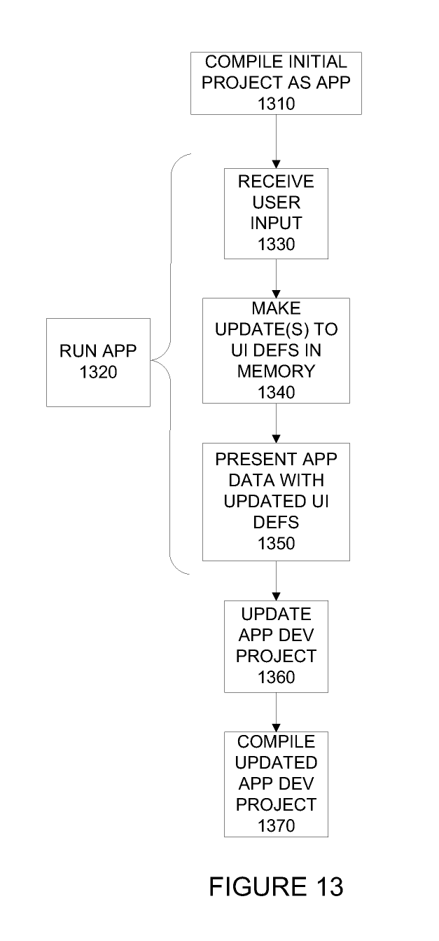

Referring to FIG. 13, another updateable running application technique will be discussed. The technique can include compiling (1310) an initial application development project as an application comprising application logic and initial user interface definitions. The application can be run (1320) to execute the application logic, load the initial user interface definitions into memory, and present application data according to the initial user interface definitions. While the application is running (1320), the technique can include receiving (1330) user input and in response to the user input making (1340) one or more updates to the initial user interface definitions in the memory to produce updated user interface definitions, and presenting (1350) the application data according to the updated user interface definitions. The technique can also include updating (1360) the initial application development project to produce an updated application development project that reflects the one or more updates to the initial user interface definitions.

Running (1320) the application can include running the application in a first process, and updating (1360) the initial application development project can be done in a second process. Moreover, updating (1360) the development project may be done on a different machine from where the application is running (1320).

The application can further include a user interface editing component, and making (1340) one or more updates to the initial user interface definitions can be done by the user interface editing component. In addition, the technique can include compiling (1370) the updated application development project as an updated application, and the updated application may omit at least some functionality of the user interface editing component (e.g., by omitting the component, disabling some functionality of the component, etc.). The updating (1360) and compiling (1370) of the application development project can be done in a development tool running in a different process from the running application.

Making (1340) the one or more updates can include updating a visual-spatial arrangement of a plurality of user interface elements. For example, updating the visual-spatial arrangement may include changing a layout of multiple user interface elements (for example, from a 2-column layout of elements to a 3-column layout of elements, from left justification to right justification of elements (as illustrated in FIGS. 8-11), etc.). As another example, making (1340) the one or more updates can include changing a property of a user interface element. For example, the property can be changed by changing a control for the user interface element from a first type of control to a second type of control. For example, as discussed above with reference to FIGS. 3-7, a control may be changed from a list control to a grid control.

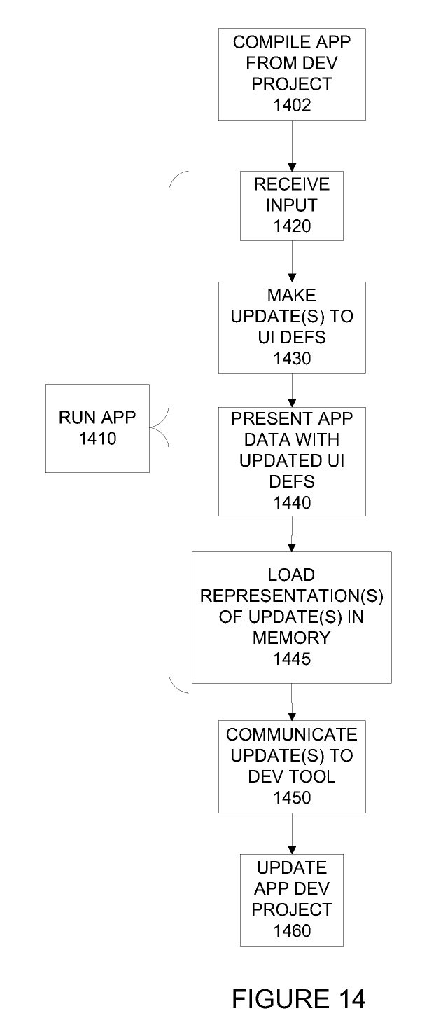

Referring to FIG. 14, yet another updateable running application technique will be discussed. The technique can include compiling (1402) an application from an initial application development project. The application can be run (1410) to execute application logic, load the initial user interface definitions for the application into memory, and present an initial user interface according to the initial user interface definitions. While the application is running (1410), user input can be received (1420). In response to the user input and also while the application is running, one or more updates can be made (1430) to the initial user interface definitions in the memory to produce updated user interface definitions, and an updated user interface can be presented (1440) according to the updated user interface definitions. For example, the update(s) can be made (1430) from the running application.

Presenting the initial user interface can include accessing application data and presenting the application data according to the initial user interface definitions. Also, presenting the updated user interface can include accessing the data and presenting the data according to the updated user interface definitions. In addition, the acts can include loading (1445) one or more representations of the update(s) in memory; this loading (1445) may also be done while the application is running (1410).

The update(s) can be communicated (1450) to a development tool running in a different process from the application. Moreover, the initial application development project can be updated (1460) to produce an updated application development project that reflects the update(s) to the initial user interface definitions. The communication (1450) and/or the updating (1460) may be done while the application is running, or at some other time. The updating (1460) of the application development project can be done in a development tool running in a different process from the running application.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

I/we claim:

1. A computer-implemented method, comprising:
running an application;
loading initial user interface definitions for the application into memory;
while continuing to run the application, performing the following:
executing the application to use the initial user interface definitions in the memory to present an initial user interface for the application;
receiving user input; and
in response to the user input, making one or more updates to the initial user interface definitions in the memory to produce updated user interface definitions in the memory, and executing the application to use the updated user interface definitions in the memory to present an updated user interface for the application.

2. The method of claim 1, further comprising communicating the one or more updates to a development tool running in a different process from the application.

3. The method of claim 1, wherein the development tool is running on a different machine from the application.

4. The method of claim 1, wherein the user input is received at the running application.

5. The method of claim 1, wherein the one or more updates are made from the running application.

6. The method of claim 1, further comprising storing updated user interface definitions that represent the one or more updates in persistent storage.

7. The method of claim 6, wherein storing the updated user interface definitions comprises storing the updated user interface definitions in an environment that includes a development tool running in a different process from the application.

8. The method of claim 6, wherein storing the updated user interface definitions comprises storing the updated user interface definitions in an environment that includes the running application.

9. The method of claim 1, further comprising cancelling the one or more updates in response to receiving additional user input, the cancelling including reverting from the updated user interface definitions in the memory back to the initial user interface definitions in the memory.

10. The method of claim 1, wherein:
executing the application to use the initial user interface definitions in the memory to present the initial user interface for the application comprises accessing application data and presenting the application data according to the initial user interface definitions; and
executing the application to use the updated user interface definitions in the memory to present the updated user interface for the application comprises accessing the data and presenting the data according to the updated user interface definitions.

11. One or more computer-readable storage media having computer-executable instructions embodied thereon that, when executed by at least one processor, cause the at least one processor to perform acts comprising:
compiling an initial application development project as an application comprising application logic and initial user interface definitions;
running the application to execute the application logic, load the initial user interface definitions into memory, and present application data according to the initial user interface definitions;
while the application is running:
receiving user input; and
in response to the user input, making one or more updates to the initial user interface definitions in the memory to produce updated user interface definitions, and presenting the application data according to the updated user interface definitions; and
updating the initial application development project to produce an updated application development project that reflects the one or more updates to the initial user interface definitions.

12. The one or more computer-readable storage media of claim 11, wherein running the application comprises running the application in a first process, and wherein updating the initial application development project is done in a second process.

13. The one or more computer-readable storage media of claim 12, wherein the application further comprises a user interface editing component, and wherein making one or more updates to the initial user interface definitions in the memory is done by the user interface editing component.

14. The one or more computer-readable storage media of claim 13, wherein the acts further comprise compiling the updated application development project as an updated application that omits at least some functionality of the user interface editing component.

15. The one or more computer-readable storage media of claim 11, wherein making the one or more updates comprises updating a visual-spatial arrangement of a plurality of user interface elements.

16. One or more computer-readable storage media having computer-executable instructions embodied thereon that, when executed by at least one processor, cause the at least one processor to perform acts comprising:
running an application to execute application logic, load initial user interface definitions for the application into memory, and present an initial user interface according to the initial user interface definitions;
while the application is running, receiving user input at the application, and in response to the user input:
making one or more updates to the initial user input definitions in the memory to produce updated user input definitions; and
presenting an updated user interface according to the updated user interface definitions; and
communicating the one or more updates to a development tool running in a different process from the application.

17. The one or more computer-readable storage media of claim 16, wherein the one or more updates are made from the running application.

18. The one or more computer-readable storage media of claim 17, wherein:
presenting the initial user interface comprises accessing application data and presenting the application data according to the initial user interface definitions; and
presenting the updated user interface comprises accessing the application data and presenting the application data according to the updated user interface definitions.

19. The one or more computer-readable storage media of claim 18, wherein the acts further comprise compiling the application from an initial application development project, and wherein the acts further comprise updating the initial application development project to produce an updated application development project that reflects the one or more updates to the initial user interface definitions.

20. The one or more computer-readable storage media of claim 19, wherein the acts further comprise loading one or more representations of the one or more updates into memory.
